(19) United States
(12) Patent Application Publication
(10) Pub. No.: US 2023/0214945 A1
(43) Pub. Date: Jul. 6, 2023

(54) ELECTRICITY TRADING CONTROL APPARATUS, ELECTRICITY TRADING CONTROL METHOD AND PROGRAM

(71) Applicant: Nippon Telegraph and Telephone Corporation, Tokyo (JP)

(72) Inventors: Naoki HANAOKA, Musashino-shi, Tokyo (JP); Hidetoshi TAKADA, Musashino-shi, Tokyo (JP); Masaki KOZAI, Musashino-shi, Tokyo (JP); Hiroya MINAMI, Musashino-shi, Tokyo (JP)

(21) Appl. No.: 17/927,099

(22) PCT Filed: May 25, 2020
(86) PCT No.: PCT/JP2020/020597

§ 371 Date: Nov. 22, 2022

(51) Int. Cl. G06Q 50/06; H02J 3/00; H02J 3/32

(52) U.S. Cl. CPC G06Q 50/06; H02J 3/008; H02J 3/32

(57) ABSTRACT

A power transaction control device for virtually performing a power transaction between a plurality of grids includes a data storage unit that stores order information about power trading between the plurality of grids, and a matching unit that establishes the power transaction between a first site of a first grid of the plurality of grids and a second site of a second grid of the plurality of grids when a pair of the first site and the second site each having an identical price for a selling order and a purchase order of power is established, and when existence of a site that interchanges balancing power identical to balancing power interchanged by the first site in the first grid and existence of a site that interchanges balancing power identical to balancing power interchanged by the second site in the second grid are detected in accordance with order information.

### TECHNICAL FIELD

The present disclosure relates to a technical field of a power transaction.

### BACKGROUND ART

Microgrids in which supply and demand of power is performed between a variety of users and suppliers through power networks in a closed area are being introduced.

In addition, one technique is to perform a balancing power transaction through a physical power cable between users by supply and demand matching in the microgrid (NPL 1).

The power transaction is desirably performed also between a plurality of different microgrids. However, power networks are sometimes unlinked between the plurality of different microgrids.

To perform the power transaction between the microgrids in which the power networks are unlinked, interposing a lithium-ion battery mounted on a physical moving object, such as an electric vehicle (EV) and a bus, is awaited. In addition, when the power transaction is performed between the microgrids across the sea, it is necessary to convey energy media other than power (crude oil, coal, LNG, hydrogen, or the like) by tankers and generate power by using the energy media.

### CITATION LIST

### Non Patent Literature

[NPL 1] A new business type contributing to sophistication of the power distribution field (The document by the bureau of study group on the ideal power platform leveraging the next-generation technology), https://www.meti.go.jp/shingikai/energy_environment/denryoku_platform/pdf/007_03_00.pdf, Searched on May 13, 2020

### SUMMARY OF THE INVENTION

### Technical Problem

As described above, to perform the power transaction between the microgrids to which the power networks are unlinked, interposing the moving object, such as the EV or the tanker, is awaited. Unfortunately, using the moving object for the power transaction takes a greater effort than using the power network, and the power transaction cannot be efficiently performed. For example, using the moving object for the power transaction fails to perform a large amount of power transaction or the power transaction in a short time.

The present disclosure has been made in view of the above circumstances, and an object of the present disclosure is to provide a technique capable of efficiently performing the power transaction between the plurality of different microgrids.

### Means for Solving the Problem

The disclosed technique provides a power transaction control device for virtually performing a power transaction between a plurality of grids, and the power transaction control device includes a data storage unit that stores order information about power trading between the plurality of grids, and a matching unit that establishes the power transaction between a first site of a first grid of the plurality of grids and a second site of a second grid of the plurality of grids when a pair of the first site and the second site each having an identical price for a selling order and a purchase order of power, and when existence of a site that interchanges balancing power identical to balancing power interchanged by the first site in the first grid and existence of a site that interchanges balancing power identical to balancing power interchanged by the second site in the second grid are detected in accordance with order information stored in the data storage unit.

### Effects of the Invention

The disclosed technology allows the efficient power transaction between the plurality of different grids.

### BRIEF DESCRIPTION OF DRAWINGS

FIG. 1 is an entire configuration diagram illustrating a system according to an embodiment of the present disclosure.

FIG. 2 is an entire configuration diagram illustrating the system of the embodiment of the present disclosure.

FIG. 3 is a diagram illustrating a configuration example of a site.

FIG. 4 is a diagram illustrating an example of a virtual power transaction.

FIG. 5 is a diagram illustrating an example of the virtual power transaction.

FIG. 6 is a diagram illustrating an example of the virtual power transaction.

FIG. 7 is a diagram illustrating an example of the virtual power transaction.

FIG. 8 is a diagram illustrating a configuration example of a power management device.

FIG. 9 is a diagram illustrating a configuration example of a power transaction control device.

FIG. 10 is a diagram illustrating a hardware configuration example of a device.

FIG. 11 is a flowchart of processing of a system.

FIG. 12 is a diagram illustrating an example of data stored in a data storage unit.

FIG. 13 is a diagram illustrating an example of information displayed on a user terminal of the site.

### DESCRIPTION OF EMBODIMENTS

Hereinafter, an embodiment of the present disclosure (the present embodiment) will be described with reference to the drawings. The embodiments to be described below are examples, and embodiments to which the present disclosure is applied are not limited to the following embodiments.

In the following description, a network of power in which supply and demand of power is performed between a consumer and a supplier through a power network in a closed area is referred to as a “grid”. The “grid” may also be referred to as a microgrid or a smart grid. The power network to be used in the grid may be a private network, a power distribution network of an electric power company, or a combination of the private network and the power distribution network of the electric power company.

In the present embodiment, although no actual supply and reception of power occurs between the grids, the power transaction is performed by assuming that the supply and reception of power virtually occurs between the grids. Such a power transaction is referred to as a “virtual power transaction”. However, the “virtual power transaction” is sometimes referred to as a power transaction or a transaction for explanatory convenience.

System Configuration

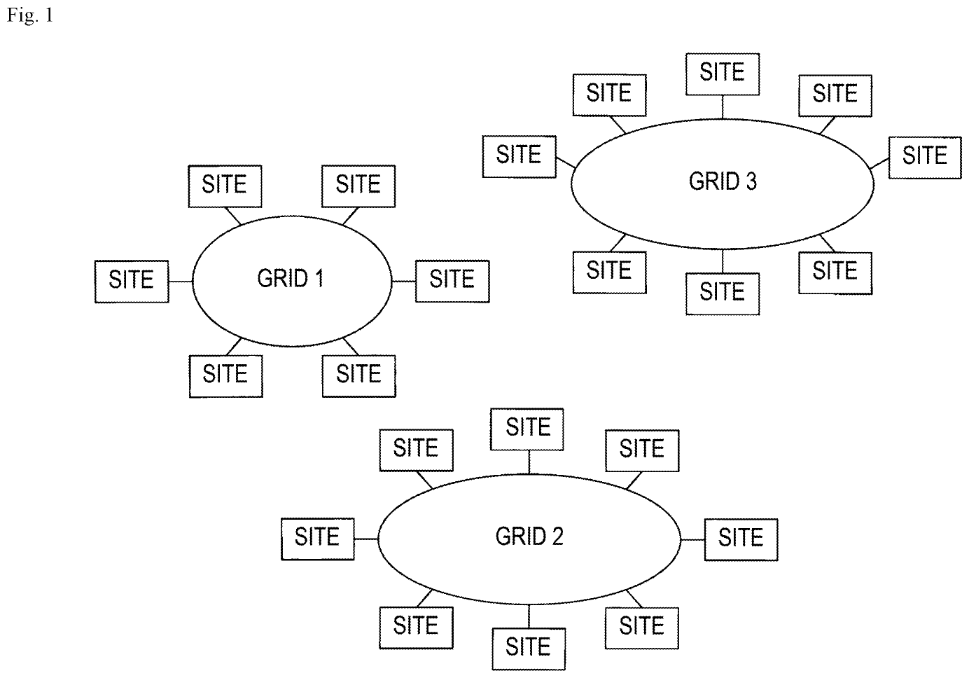

FIG. 1 illustrates a configuration example of a system related to a power network (referred to as a power network system) in the embodiment of the present disclosure. As illustrated in FIG. 1, the power network system according to the present embodiment includes a plurality of grids. FIG. 1 illustrates grids 1 to 3 as an example of the plurality of grids. It is assumed that the grids are not connected by a power cable, but the grids may be connected by the power cable. However, the power transaction with the actual supply and reception of power between the grids is not performed in the present embodiment.

Also, the grids 1 to 3 may be disposed in one country or distributed in a plurality of countries.

A plurality of sites are connected to each grid. In terms of power supply and power demand, each site may be any of a site including only a power generation facility, a site including a power generation facility and a power consuming device, or a site including only the power consuming device. In addition, a storage battery may be provided at the site, and there may be the site including only the storage battery.

Each site may be operated by an enterprise or may be a standard home or others. In addition, one grid may include a plurality of sites (a plant, office, a power generation facility, and the like) that are operated by one enterprise.

The power generation facility may be a facility of renewable energy generation such as water force, wind force, geothermal energy, biomass, and sunlight or a facility such as thermal power generation, a nuclear power generation, and an engine.

In each grid, each site can perform power interchange (power distribution and power reception) with another site through the power cable.

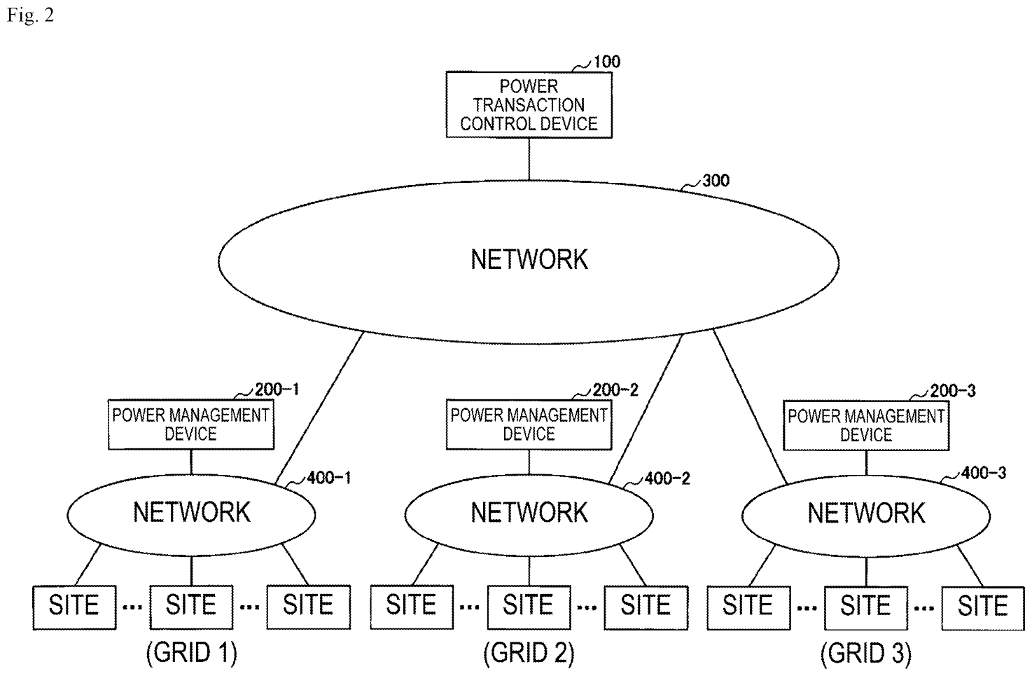

FIG. 2 is a configuration diagram illustrating a system (referred to as a power transaction control system) related to power transaction control of the present embodiment. FIG. 2 illustrates a power transaction control system in the power network system in FIG. 1. In FIG. 2, “1” in “200-1”, “400-1”, and the like corresponds to the grid 1. The same applies to the grids 2 and 3. When describing a common matter between the grids, the description is made without “1” or the like.

As illustrated in FIG. 2, a power management device 200 is provided for each grid, and the power management device 200 is connected to a network 400 along with each site in the corresponding grid. For example, the network 400 is a LAN in the case of a small-scale grid. For example, the network 400 is an access network that is provided by a local telephone company in the case of a certain degree of a large-scale grid. The network 400 may be a wireless network such as a wireless LAN or a 5G network.

Each site in the grid can communicate with the power management device 200 through the network 400. Each site and the power management devices 200 can communicate with a power transaction control device 100 through the network 400 and a network 300.

The network 400 and the power transaction control device 100 are connected to the network 300. For example, the network 300 is the Internet.

The power management device 200 performs power interchange control and the like in the grid. The power transaction control device 100 performs the virtual power transaction between the grids.

In the present embodiment, it is assumed that a person in charge (referred to as a user) of the power transaction is in each site, and that the user accesses the power transaction control device 100 from the user terminal of the site and issues the purchase order, the selling order, and the like to perform the power transaction. A person (user) of the power transaction is in each grid, and the user may output the purchase order, the selling order, and the like for all the sites in the user's own grid.

In the present embodiment, a deal of payment is generated due to the power transaction between the grids, but the supply and reception of power (power interchange) between the grids is not generated due to the power transaction between the grids. Details of the virtual power transaction will be described below.

Configuration Example of Site

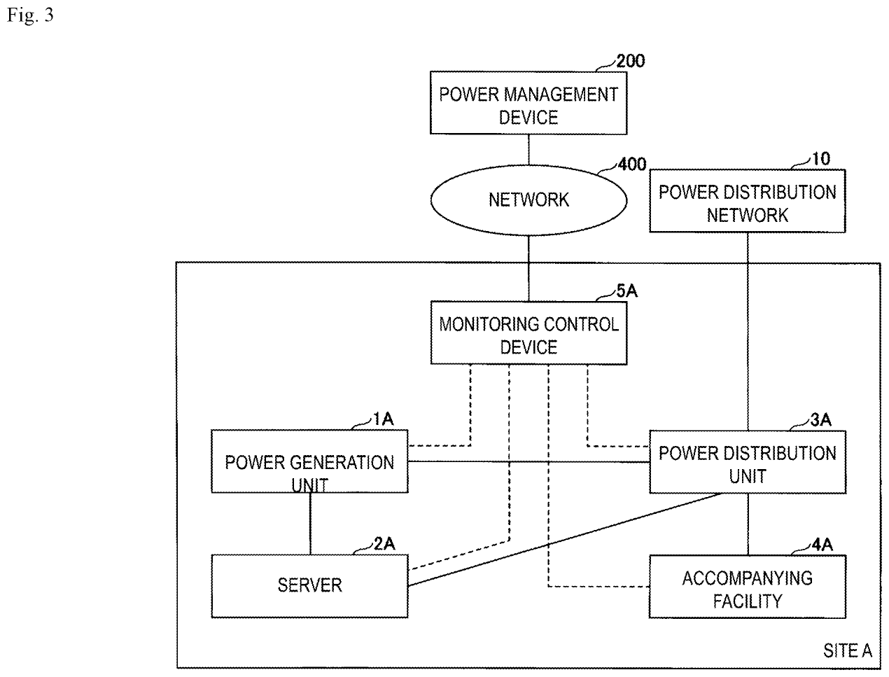

FIG. 3 illustrates a configuration example of a site (site A) in a certain grid. The site A is an example of a site including both the power generation facility and the power consuming device, and is a data center or the like.

As illustrated in FIG. 3, the site A includes a power generation unit 1A that generates the power using renewable energy such as sunlight, a server 2A that is an example of the power consuming device, a power distribution unit 3A connected to a power distribution network 10A of the grid, an accompanying facility 4A such as lighting of an air conditioning unit and a server room, and a monitoring control device 5A.

The power distribution unit 3A supplies the power received from the power distribution network 10 to the server 2A and the accompanying facility 4A. However, when the power generation unit 1A is sufficiently generated (when the voltage is high), the power supply to the server 2A is performed by the power generation unit 1A. In addition, the power distribution unit 3A can distribute the excess power in the power generated by the power generation unit 1A to another site in the same grid according to the result of the power transaction.

The monitoring control device 5A can perform control communication with an individual portion through an intra-site communication network. Further, the monitoring control device 5A is connected to the power management device 200 through the network 400. For example, the monitoring control device 5A performs the control of distributing the power generated by the power generation unit 1A to another site through the power distribution network 10 based on an instruction from the power management device 200. When the storage battery is provided, the monitoring control device 5A can notify the power management device 200 of a residual power storage amount and the like.

Example of Virtual Power Transaction

In the present embodiment, the power transaction control device 100 receives an order (purchase order, selling order) related to the power deal between the grids from the user of each site, and establishes the power transaction by performing the matching of the order. In the matching of the order, basically the transaction is established in the same order pair in which a price of the power in the purchase order is equal to a price of the power in the selling order.

As described above, the deal of the payment is generated between the grids due to the power transaction, but the power interchange (may also be referred to as the supply and reception of power) between the grids is not generated. The power interchange is performed between the sites in the grid. The power interchange between the sites in the grid is performed by the balancing power in a power distribution side and a power reception side.

In addition, the present embodiment has a unit power amount (for example, 10 kWh) as a transaction amount of the power transaction. The price of the power per unit power amount is referred to as a unit price. The transaction is performed in an amount of an integer multiple of the unit power amount. The unit power amount may be different in each site. Furthermore, the unit power amount may not be provided. In the following specific description, by way of example, the unit power amount common to all sites is set to 10 kWh. In this case, the transaction unit kWh of the power market is described in the transaction amount as an example, but it is also possible to take the transaction unit kW of a capacity market and the transaction unit ΔkW of a supply and demand adjustment market.

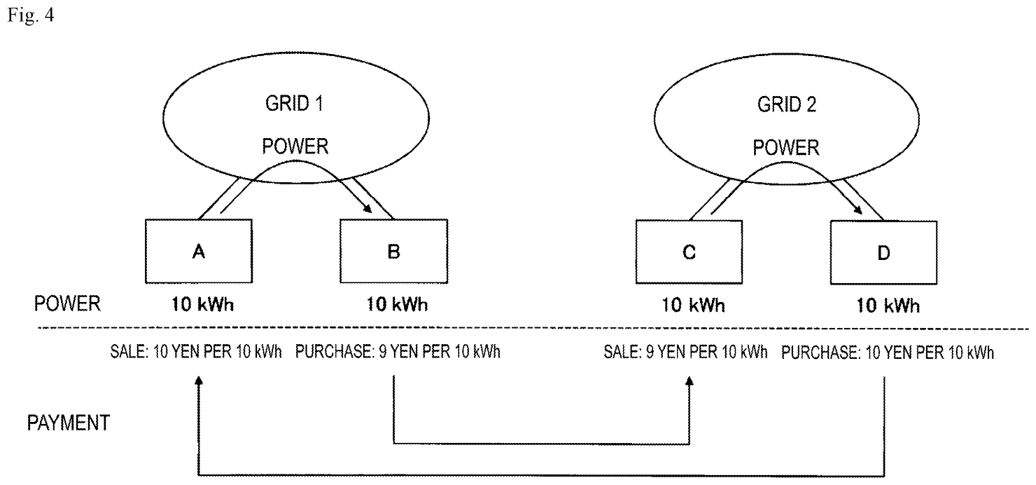

With reference to FIGS. 4 to 7, Example 1 to Example 4 of the power transaction of the present embodiment will be described.

### Example 1

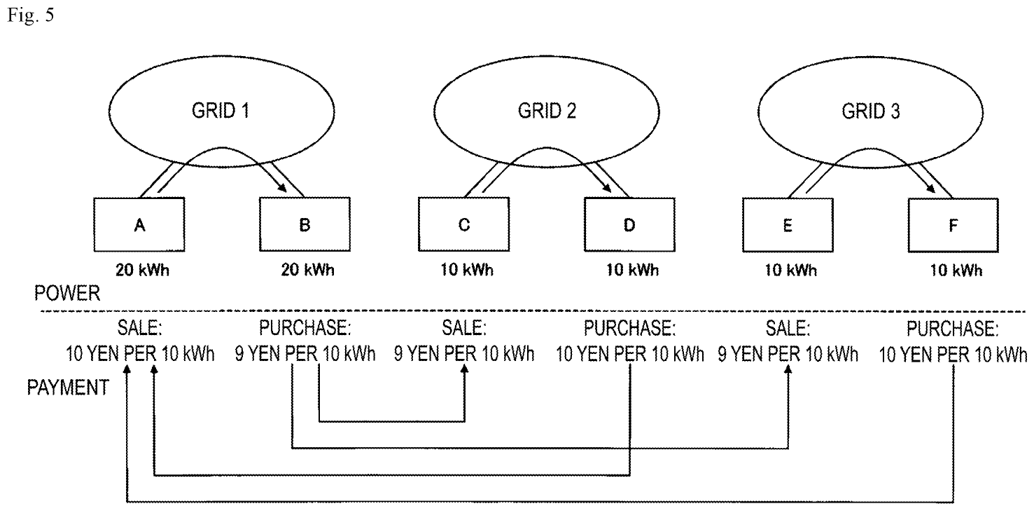

FIG. 4 is a diagram illustrating an example of the power transaction between the grid 1 and the grid 2. In FIG. 4 (also similar to FIGS. 5 to 7), an upper side above a dotted line indicates the deal of the power, and a lower side below the dotted line indicates the deal of the payment related to the power transaction. With respect to the deal of the payment, the deal of the payment may be performed directly between a seller and a purchaser, or performed through an agent (settlement company and the like).

In the example of FIG. 4, the site A of the grid 1 sells the power amount of 10 kWh to the site D of the grid 2 at the unit price of 10 yen, and the site D of the grid 2 purchases the power amount of 10 kWh from the site A of the grid 1 at the unit price of 10 yen. In addition, the site C of the grid 2 sells the power amount of 10 kWh to the site B of the grid 1 at the unit price of 9 yen, and the site B of the grid 1 purchases the power amount of 10 kWh from the site C of the grid 2 at the unit price of 9 yen.

With respect to the actual power interchange, in the grid 1, the power amount of 10 kWh is supplied from the site A to the site B. In the grid 2, the power amount of 10 kWh is supplied from the site C to the site D. The control of the power distribution is performed by the power management device 200 of the corresponding grid performs based on the instruction from the power transaction control device 100.

As described above, when the two pairs of the seller and the purchaser each having an identical price are established between the grids such that the balancing power is interchanged in each grid, the transaction is established, the power is interchanged in each grid, and the deal of the payment is performed between the grids. In this example, because the seller and the purchaser are 1:1, the seller and the purchaser in the identical quantity at the identical price are paired. However, in the case of 1:N or N:1 described later, the power amount of the order is not identical in the pair of one seller and one purchaser.

When a power distribution network of an electric power company is used for the power interchange between the sites in each grid, a power user (the site at which the power is received) pays a consignment charge to the power company. However, in the present embodiment, proportional division (for example, payment one half each) of the consignment charge may be performed between the site in which the power is distributed and the site in which the power is received. In the following description, it is assumed that the consignment charge is not considered.

In the example of FIG. 4, when the site D in the grid 2 that purchases the power amount of 10 kWh at 10 yen purchases the power amount of 10 kWh from the site C in the same grid 2, the power amount of 10 kWh can be purchased at 9 yen.

In the present embodiment, because the power transactions in the grid as described above are not assumed, actually the power transaction is not established. In the present embodiment, for example, the site A is a famous enterprise having a high brand value, the site D has an incentive to purchase the power although the price is high in terms of the use of the power purchased from such a famous enterprise.

In addition, for example, when the power supplied by the site A is the power due to the renewable energy generation, the site D purchases the power although the price is high, counting an environmental added value of the power supplied by the site A. That is, in this case, the environmental added value is included in the price of the power in the selling order transmitted from the site A that generates the power by the renewable energy generation.

In addition, the site A that sells the power at the price including the environmental added value may provide a certificate proving the purchase of the power due to the renewable energy generation on the purchaser of the power. The purchaser having the certificate may be considered to be utilizing the power generated by the renewable energy.

In addition, a point is provided to the purchaser or the seller of the power using the virtual power transaction of the present embodiment or both the purchaser and the seller, and the provided point can be applied to a part of the price in the purchase order or the selling order, so that the incentive for the purchase can be provided although the price is high.

### Example 2

In Example 1, the number of sellers of each transaction between the grids and the number of purchasers are 1:1. However, the number of sellers and the number of purchasers may be 1:N or N:1. N is an integer of 2 or more.

FIG. 5 is a diagram illustrating Example 2 of the power transaction in the case where N is 2. In the example of FIG. 5, the site A of the grid 1 sells the power amount of 10 kWh to each of the site D of the grid 2 and the site F of the grid 3 at the unit price of 10 yen, and each of the site D of the grid 2 and the site F of the grid 3 purchases the power amount of 10 kWh from the site A of the grid 1 at the unit price of 10 yen.

In addition, the site B of the grid 1 purchases the power amount of 10 kWh from each of the site C of the grid 2 and the site E of the grid 3 at the unit price of 9 yen, and each of the site C of the grid 2 and the site E of the grid 3 sells the power amount of 10 kWh to the site B of the grid 1 at the unit price of 9 yen.

As described above, “seller:purchaser=(site A):(site D, site F)=1:2” and “seller:purchaser=(site C, site E):(site B)=2:1”.

For the balancing power interchange, the power amount of 20 kWh is distributed from the site A to the site B in the grid 1. In the grid 2, the power amount of 10 kWh is supplied from the site C to the site D. In the grid 3, the power amount of 10 kWh is supplied from the site E to the site F.

### Example 3

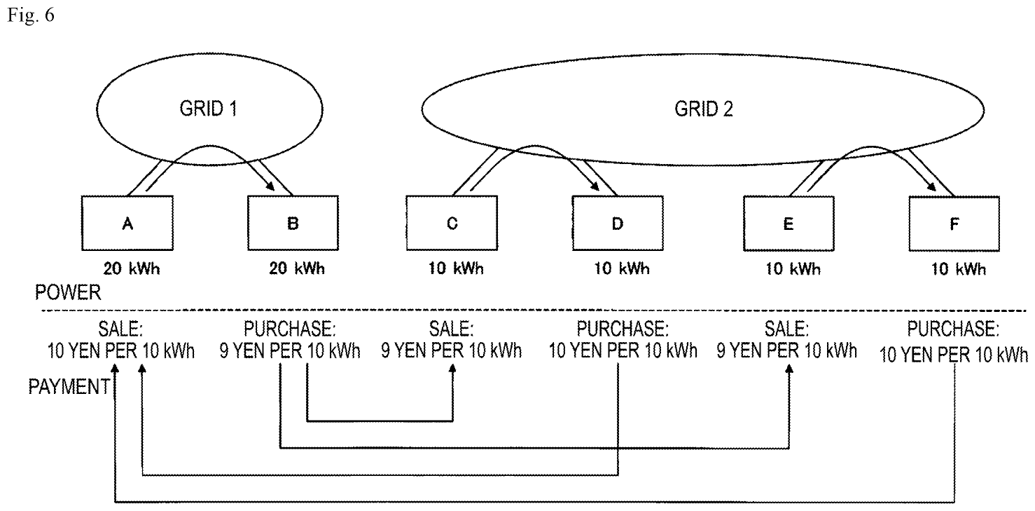

FIG. 6 is a diagram illustrating Example 3 that is another example of the power transaction in the case where N is 2. In the example of FIG. 6, the site A of the grid 1 sells the power amount of 10 kWh to each of the site D of the grid 2 and the site F of the grid 2 at the unit price of 10 yen, and each of the site D of the grid 2 and the site F of the grid 2 purchases the power amount of 10 kWh from the site A of the grid 1 at the unit price of 10 yen.

In addition, the site B of the grid 1 purchases the power amount of 10 kWh from each of the site C of the grid 2 and the site E of the grid 2 at the unit price of 9 yen, and each of the site C of the grid 2 and the site E of the grid 2 sells at the power amount of 10 kWh to the site B of the grid 1 at the unit price of 9 yen.

As described above, “seller:purchaser=(site A):(site D, site F)=1:2” and “seller:purchaser=(site C, site E):(site B)=2:1”.

For the balancing power interchange, the power amount of 20 kWh is distributed from the site A to the site B in the grid 1. In the grid 2, the power amount of 10 kWh is supplied from the site C to the site D, and the power amount of 10 kWh is supplied from the site E to the site F.

### Example 4

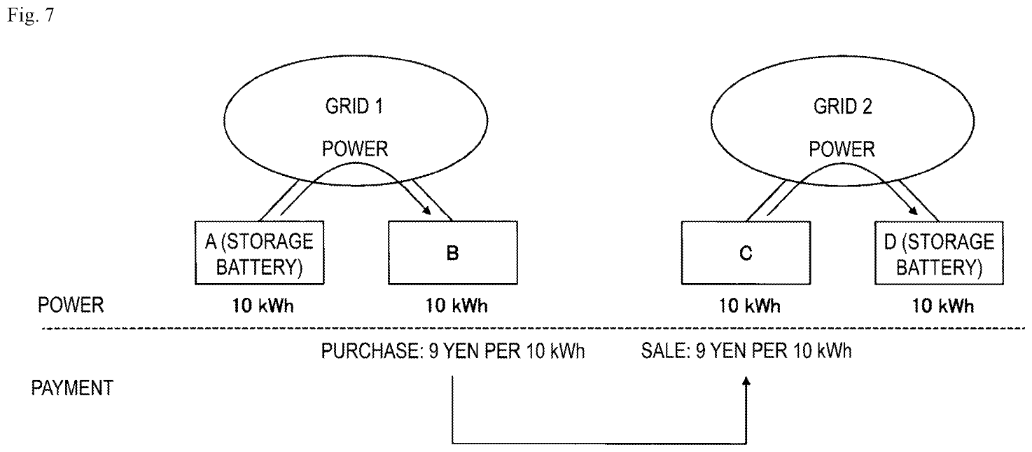

FIG. 7 is a diagram illustrating Example 4 of the power transaction between the grid 1 and the grid 2.

Examples 1 to 3 described in FIGS. 4 to 6 illustrate an example in which a plurality of pairs of the seller and the purchaser each having an identical price are established between the grids such that the balancing power interchange is performed in each grid.

It is also thought that the plurality of pairs of the seller and the purchaser each having an identical price are not established between the grids such that the balancing power is interchanged in each grid.

Thus, to enable the transaction to be established in the case where the pair is not established such that the balancing power is interchanged in each grid, Example 4 uses the site including the storage battery for the balancing power interchange in the grid. In the example of FIG. 7, the site A of the grid 1 and the site D of the grid 2 correspond to such a point.

In the example of FIG. 7, for example, it is assumed that the site B of the grid 1 places the purchase order that the power amount of 10 kWh is purchased at 9 yen, and that the site C of the grid 2 places the selling order that the power amount of 10 kWh is sold at 9 yen.

Although the two orders described above have the identical quantity and the identical price, the balancing power cannot be interchanged in each grid, and thus the transaction is not established between the two orders.

On the other hand, in Example 4, the transaction is established between the two orders described above, and the storage battery of the site A in the grid 1 discharges the power amount of 10 kWh and distributes the power to the site B, and the storage battery of the site D receives and stores the power amount of 10 kWh from the site B.

In this case, for example, the operation of the storage battery for the virtual power transaction as described above is performed by a virtual charging and discharging company. The user (the site B and site C in the example of FIG. 7) that performs the virtual power transaction using the storage battery may pay a fee to the virtual charging and discharging company.

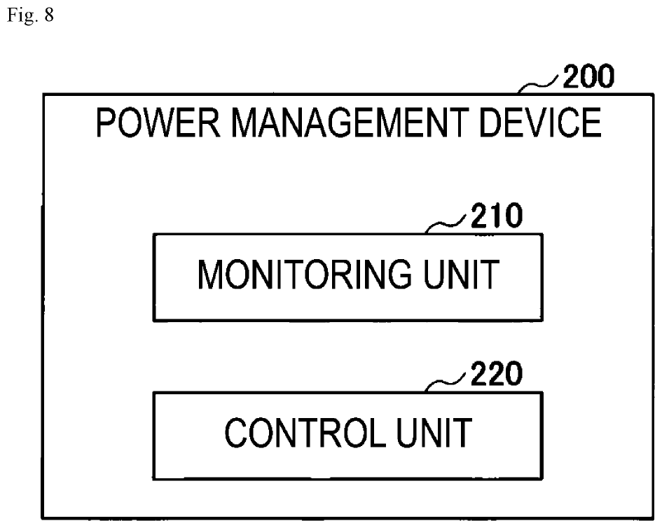

Configuration Example of Power Management Device 200 FIG. 8 illustrates a configuration example of the power management device 200. As illustrated in FIG. 8, the power management device 200 includes a monitoring unit 210 and a control unit 220. As described above, in the present embodiment, the power management device 200 is provided for each grid. The grid in which the power management device 200 is included is referred to as a target grid.

The monitoring unit 210 monitors each site in the target grid and notifies the power transaction control device 100 of information obtained by monitoring. For example, the information obtained in the monitoring is the residual power storage amount (a ratio of full charge to the power storage amount and the like) at each site including the storage battery (storage unit). Furthermore, for example, the information obtained by the monitoring may be a state in which the power is distributed from a certain site to another site (power distribution start, power to be distributed (current, voltage), and power distribution end, and the like).

The control unit 220 receives the instruction from the power transaction control device 100 and interchanges the balancing power between the sites in the target grid based on the instruction.

Configuration Example of Power Transaction Control Device 100

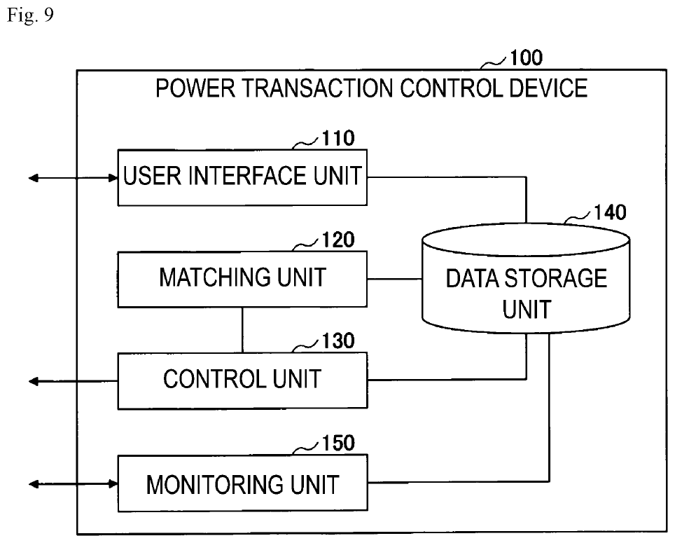

FIG. 9 illustrates a configuration example of the power transaction control device 100 of the present embodiment. As illustrated in FIG. 9, the power transaction control device 100 of the present embodiment includes a user interface unit 110, a matching unit 120, a control unit 130, a data storage unit 140, and a monitoring unit 150.

The user interface unit 110 provides a power transaction screen for the user terminal of each site and receives information input to the user terminal through the power transaction screen. The user interface unit 110 may be referred to as a “reception unit”.

The data storage unit 140 stores the information about the order received from the user terminal by the user interface unit 110 and the information about the site collected from each site of each grid by the monitoring unit 150 (the residual power storage amount of the storage battery in each grid or in each site, and the like).

The matching unit 120 refers to the information stored in the data storage unit 140 to perform the matching of the order of the seller and the order of the purchaser based on the purchase order/selling order from each site of each grid. The matching is to determine the purchaser and seller pair that establishes the transaction.

The control unit 130 instructs the power management device 200 to instruct the site that actually interchanges the power in reference to the established transaction (the site that distributes the power and the site that receives the power) to distribute and receive power. The control unit 130 may directly (not through the power management device 200) instruct the power interchange to each site.

In addition, the control unit 130 may perform processing of the payment of the settlement (the payment of the delivery) to the purchaser and the seller of the established transaction. Furthermore, the control unit 130 may perform the processing for providing the points to both or each of the purchaser and the seller of the established transaction. For example, the processing for providing the point may inform a point operation company of the point acquired by the purchaser/seller.

The monitoring unit 150 receives information such as the state of the power interchange, the residual power storage amount of the storage battery in each site including the storage battery, and the like from the power management device 100 of each grid, and stores the received information in the data storage unit 140. Details of the processing performed by the power transaction control device 100 will be described later.

Hardware Configuration Example

For example, the power transaction control device 100 and the power management device 200 in the present embodiment can be implemented by causing a computer to execute a program describing the processing content described in the present embodiment. Further, the “computer” may be a physical machine or a virtual machine on cloud. In a case where a virtual machine is used, “hardware” to be described here is virtual hardware.

The above program can be stored or distributed with the program recorded on a computer readable recording medium (such as a portable memory). In addition, the above program can also be provided through a network such as the Internet or e-mail.

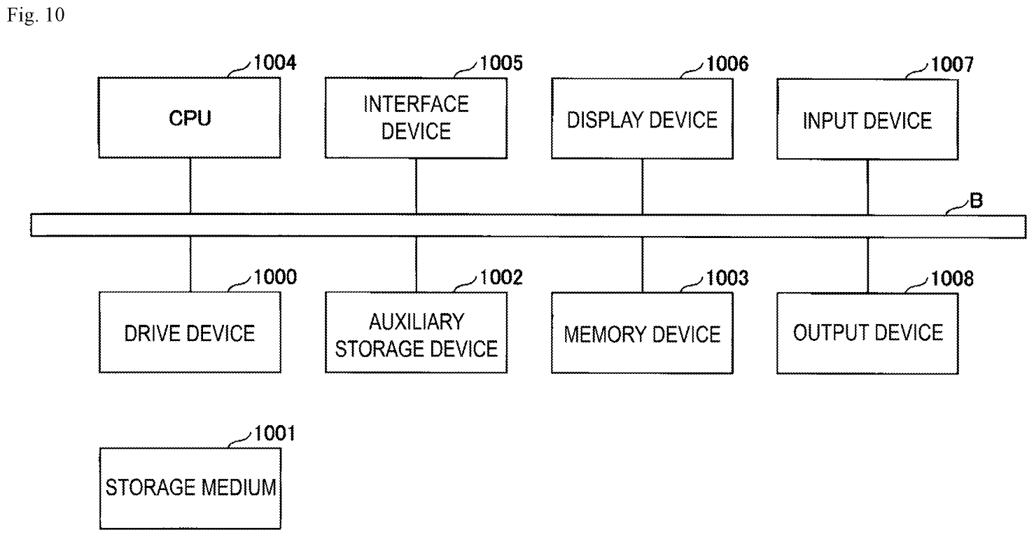

FIG. 10 is a diagram illustrating an example of a hardware configuration of the above-described computer. The computer in FIG. 10 includes a drive device 1000, an auxiliary storage device 1002, a memory device 1003, a CPU 1004, an interface device 1005, a display device 1006, an input device 1007, and an output device 1008 that are connected to each other through a bus B S.

A program for implementing processing in the computer is provided by means of a recording medium 1001 such as a CD-ROM or a memory card. When the recording medium 1001 having a program stored therein is set in the drive device 1000, the program is installed from the recording medium 1001 through the drive device 1000 to the auxiliary storage device 1002. However, the program does not necessarily have to be installed from the recording medium 1001, and may be downloaded from another computer through a network. The auxiliary storage device 1002 stores the installed program, and stores necessary files, data, and the like.

In response to an activation instruction of the program, the memory device 1003 reads out the program from the auxiliary storage device 1002 and stores the program. The CPU 1004 achieves functions related to the apparatus in accordance with the program stored in the memory device 1003. The interface device 1005 is used as an interface for connection to a network. The display device 1006 displays a graphical user interface (GUI) or the like based on the program. The input device 1007 includes a keyboard, a mouse, a button, a touch panel, or the like, and is used for inputting various operation instructions. The output device 1008 outputs the calculation result.

Operation Example of Power Transaction Control Device 100

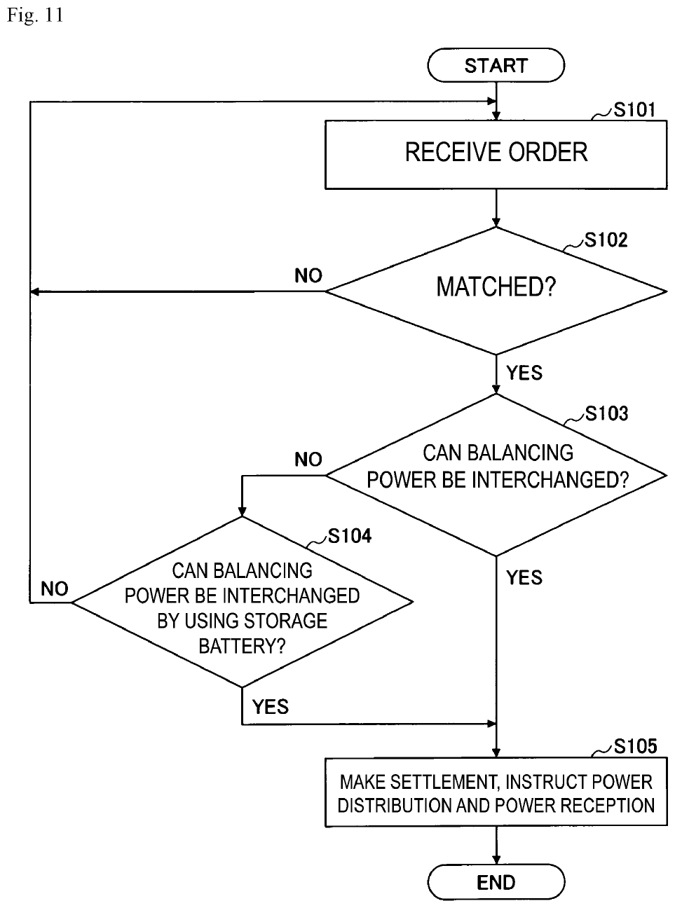

An operation example of the power transaction control device 100 will be described below along the procedure of the flowchart in FIG. 11.

S101

In S101, the user interface unit 110 of the power transaction control device 100 receives the order from a user terminal at the site of the grid. The order is received at any time from the user terminal of at least one site of at least one grid. The orders in the present embodiment have a limit order and a market order.

For example, the limit order may include information about “selling/purchasing, price (unit price), power amount, power type”. Also, the market order includes information about “selling/purchasing, power amount, power type”. In both the case of the limit order and the market order, “power type” may not be included. In addition, in both the case of the limit order and the market order, the grid (information identifying a desired transaction partner) of the desired transaction partner may be included in the order.

In addition, in both the case of the limit order and the market order, the grid and the site of the desired transaction partner may be included in the order. In order, a time (in the case of the purchase order) at which the demand of the power (power reception) is desired and a time (in the case of the selling order) at which the supply (power distribution) is desired may be included in the order.

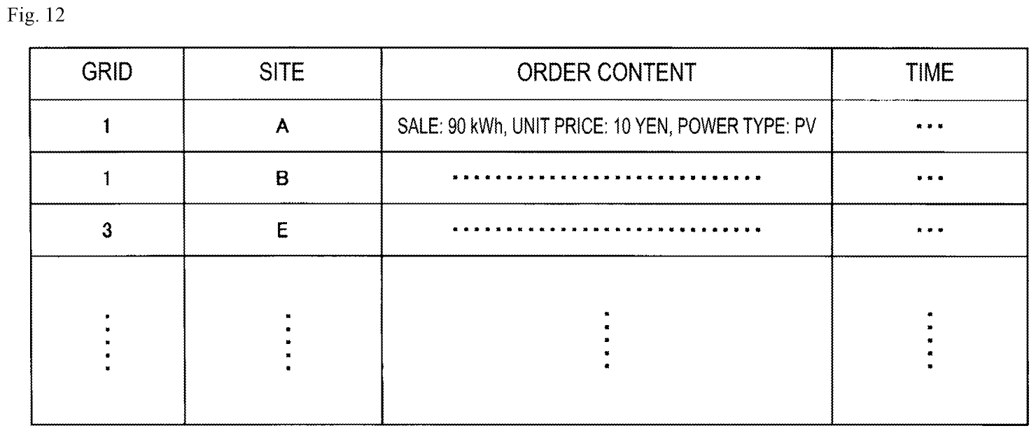

The user interface unit 110 stores information about the received order in the data storage unit 140. FIG. 12 is a diagram illustrating an example of order information stored in the data storage unit 140.

The “grid” and the “site” in FIG. 12 are the “grid” and the “site” of an issuing source of the order. The existence of the purchase order means that the demand of the power of the order amount is wanted in the “grid” and the “site” of the issuing source, and the existence of the selling order means that the power distribution of the order amount is wanted in the “grid” and the “site” of the issuing source.

The “order content” is information about the order described above. In the example of FIG. 12, the order of “selling, 90 kWh, unit price of 10 yen, power type: PV” is offered from the grid 1 and the site A. PV means the power obtained by solar power generation.

The “time” in FIG. 12 becomes a time at which the order is specified when the time (the time at which the power reception/power distribution is desired) is designated, and the “time” in FIG. 12 becomes a time at which the order is received when the time is not designated.

In the present embodiment, it is assumed that basically the designation of the time is not required, that the user (orderer) who desires the power reception/power distribution places the order at the time at which the power reception/power distribution is desired, and that the power reception/power distribution is instantly performed. However, “the time at which the power reception/power distribution is desired” is the time in which the time until the establishment of the transaction is estimated. For example, the order may be performed at 15:00 to initiate the actual power reception/power distribution at 16:00 and the like.

In addition, when the time is designated, for example, the time of the future time such as the time after 2 hours from the current time is designated.

With respect to the matching, the matching is performed between the orders in which the time is not designated, and the matching is performed between the orders designated at the same time. A difference between times within a predetermined time (for example, 2 hours) may be regarded as “the same time”.

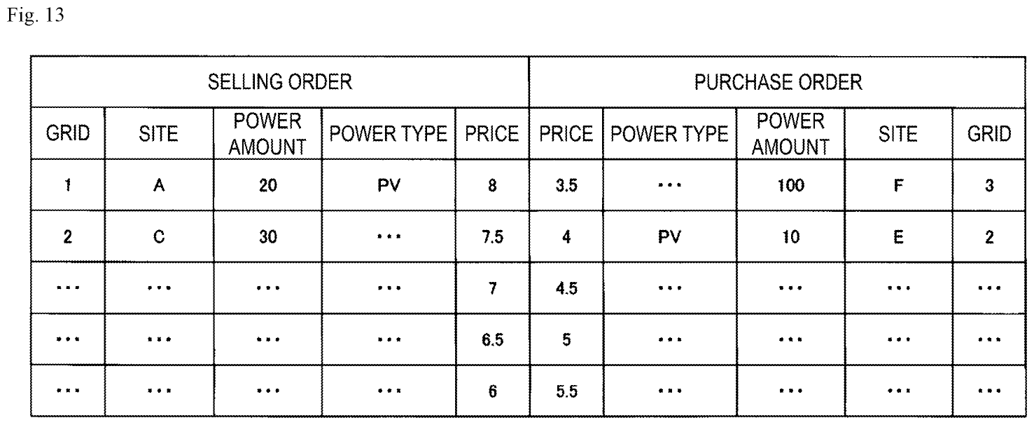

In S101, based on the order information stored in the data storage unit 140, the user interface unit 110 displays the screen on the user terminal. FIG. 13 illustrates an example of the screen displayed on the user terminal. In the example of FIG. 13, the user terminal displays the selling order and the purchase order, and displays the grid, the site, the power type, the power amount, and the price for each of the selling order and the purchase order.

The user who operates the user terminal can check information and place the order. For example, it is conceivable that the user of a certain site on a certain grid considers that the user wants to purchase the power of the PV (solar power generation) from the well-known enterprise located at the site A of the grid 1 at high price, and that the user places the order of the power of the site A of the grid 1 at the unit price of 8 yen (or the market order purchasing the power of the site A of the grid 1).

S102, S103, S104

In S102, the matching unit 120 performs matching processing based on information (the order information, the remaining amount information about the storage battery, and the like) stored in the data storage unit 140. The matching process may be performed periodically (for example, every hour) or performed every time of receiving the order.

Basically, the matching unit 120 performs the matching of the selling order (the order of the seller who sells the power cheap) in ascending order of the unit price, and performs the matching of the purchase order (the order of the purchaser who purchases the power high) in descending order of the unit price. In the matching, the purchase order and selling order pair in which the unit prices are equal is determined in the case of the limit order. The selling order in which the unit price is low is preferentially matched for the market purchase order, and the purchase order in which the unit price is high is preferentially matched for the market selling order.

For the power amount, the pair is preferentially determined when the order of the same power amount for the purchasing and selling exists, and then the pair of 1:N or N:1 is determined such that the power amounts are matched with each other for the purchasing and selling.

In addition, when the grid/site/power type/time of the power to be purchased is desired, the matching is performed so as to match the desired grid/site/power type/time. The transaction is not established only when the selling and purchase pair is determined.

In the matching, for example, when a plurality of sites place the purchase order on the power which a certain site sells, a system of first come, first served may be used, or the matching may be performed using a system called a “reception retention system” in a matching theory. The matching itself of “the receiving retention system” is a known technique.

When “the reception retention system” is used, because desired order and priority order are used in “the reception retention system”, the desired order may be included in the purchase order. For example, when the site where the PV power is sold at the identical price is three of the site A, the site B, and the site C, for example, the purchaser who wants to purchase the PV power at this price places the purchase order including the desired order such as “1: site B, 2: site C, 3: site A”. For example, the matching unit 120 determines the priority order of the purchaser such that for example, higher the past transaction amount, higher the priority order.

For example, as illustrated in FIG. 4, such matching processing determines two pairs of “the site A of the grid 1 sells the power amount of 10 kWh at the unit price of 10 yen: the site D of the grid 2 purchases the power amount of 10 kWh at the unit price of 10 yen” and “the site C of the grid 2 sells the power amount of 10 kWh at the unit price of 9 yen: the site B of the grid 1 purchases the power amount of 10 kWh at the unit price of 9 yen”. When the pair is determined by the matching, S102 becomes affirmative, and the processing proceeds to S103. When the pair is not determined by the matching, S102 becomes negative, and the processing returns to S101.

In S103, the matching unit 120 determines whether the balancing power can be interchanged in each grid for the pair determined in S102. For example, in the example of FIG. 4, the balancing power can be interchanged in each of the grid 1 and the grid 2 as illustrated in FIG. 4, and S103 proceeds Yes. When S103 becomes affirmative, the matching unit 120 holds the transaction in the two pair described above, and the processing proceeds to S105.

In S103, when the balancing power cannot be interchanged in each grid, and when only the pair of “the site C of the grid 2 that sells the power amount of 10 kWh at the unit price of 9 yen and the site B of the grid 1 that purchases the power amount of 10 kWh at the unit price of 9 yen” shown in FIG. 7 is determined, the processing goes to S104. In S103, when the balancing power cannot be interchanged in each grid, the processing may return to S102, and the matching may be performed again such that the other pair is determined.

In S104, the matching unit 120 determines whether the balancing power can be interchanged in each grid by using the storage battery based on the remaining power storage information about the storage battery of each site of each grid stored in the data storage unit 140.

For example, as illustrated in the example of FIG. 7, when only the pair of “the site C of the grid 2 that sells the power amount of 10 kWh at the unit price of 9 yen and the site B of the grid 1 that purchases the power amount of 10 kWh at the unit price of 9 yen” is determined, and when it is found that the storage battery capable of supplying the power amount of 10 kWh in the grid 1 is in site A while the storage battery capable of receiving (accumulating) the power amount of 10 kWh in the grid 2 is in the site D based on the information stored in the data storage unit 140, it is determined that the balancing power can be interchanged in each grid by using the storage battery.

When the determination result of S104 is affirmative, the transaction of the above-described pair is established, and the processing proceeds to S105. When the determination result in S104 is negative, the processing returns to S101.

S105

In S105, the control unit 130 performs settlement processing (the deal of the payment) for the pair between the grids in which the transaction is established, and instructs the corresponding power management device 200 to instruct the site of the pair in each grid that interchanges the balancing power to distribute and receive the power. For the settlement processing, the settlement company may be performed by notifying the settlement company of the pair between the grid with which the transaction is established and the order content. The processing for having a settlement company make settlement processing may be referred to as “settlement processing”.

For the balancing power interchange, when, for example, the transaction shown in FIG. 4 is established, the control unit 130 of the power transaction control device 100 transmits instruction information indicating “the distribution of the power amount of 10 kWh from the site A to the site B” to a power management device 200-1 of the grid 1, and transmits instruction information indicating “the distribution of the power amount of 10 kWh from the site C to the site D” to a power management device 200-2 of the grid 2.

In the power management device 200-1 that receives instruction information of “the distribution of the power amount of 10 kWh from the site A to the site B”, a control unit 220-1 instructs the site A to distribute the power amount of 10 kWh to the site B and instructs the site B to receive the power amount of 10 kWh from the site A.

In the power management device 200-2 that receives instruction information of “the distribution of the power amount of 10 kWh from the site C to the site D”, a control unit 220-2 instructs the site C to distribute the power amount of 10 kWh to the site D and instructs the site D to receive the power amount of 10 kWh from the site C.

When the transaction is established in the pair designated by the time, the processing of S105 is performed at the designated time.

Effects of Embodiments

The technique according to the present embodiment allows for efficiently performing the power transaction between the plurality of different grids that are unlinked with the power network without the need of aggregation. Specifically, a large amount of the power transaction or the power transaction at a short time can be performed between the plurality of different grids that are unlinked with the power network. Also, the power transaction between different countries can be performed.

In addition, the transaction is made between the grids, so that the number of transactions can be increased even with the grid with small numbers (the number of sites). For example, in the grid, even when the purchaser is hardly found for the site in which excess power is to be sold, there is a possibility that the purchaser in another grid can be quickly found by the technique of the present embodiment.

Furthermore, as described in FIG. 7, the storage battery can be actively charged and discharged, so that the site including the storage battery gets income.

### Conclusion of Embodiments

The present specification describes at least a power transaction control device, a power transaction control method, and a program described in the following items.

Item 1

A power transaction control device for virtually performing a power transaction between a plurality of grids, the power transaction control device including:
a data storage unit that stores order information about power trading between the plurality of grids; and
a matching unit that establishes the power transaction between a first site of a first grid of the plurality of grids and a second site of a second grid of the plurality of grids when a pair of the first site and the second site each having an identical price for a selling order and a purchase order of power site of a first grid and a second site of a second grid is established, and when existence of a site that interchanges balancing power identical to balancing power interchanged by the second site in the second grid is detected in accordance with order information stored in the data storage unit.

### Item 2

The power transaction control device according to item 1, wherein
the matching unit further establishes a transaction of power trading between the site that interchanges the balancing power identical to the balancing power interchanged by the first site and the site that interchanges the balancing power identical to the balancing power interchanged by the second site.

### Item 3

The power transaction control device according to item 1, wherein
the site that interchanges the balancing power identical to the balancing power interchanged by the first site and the site that interchanges the balancing power identical to the balancing power interchanged by the second site each include a storage battery and distribute and receive power between the storage battery of the site that interchanges the balancing power identical to the balancing power interchanged by the first site and the storage battery of the site that interchanges the balancing power identical to the balancing power interchanged by the second site.

### Item 4

The power transaction control device according to any one of items 1 to 3, including
a reception unit that receives the purchase order or the selling order from an individual site of each of the plurality of grids, wherein
an environmental added value is included in a price of power in the selling order received from a site that generates power by renewable energy.

### Item 5

The power transaction control device according to any one of items 1 to 4, including
a control unit that gives a point to at least one of a purchaser or a seller of power when the power transaction is established.

### Item 6

A power transaction method for virtually performing a power transaction between a plurality of grids performed by a power transaction control device,
the power transaction control device including a data storage unit that stores order information about power trading between the plurality of grids,
the power transaction method including
establishing the power transaction between a first site of a first grid of the plurality of grids and a second site of a second grid of the plurality of grids when a pair of the first site and the second site each having an identical price for a selling order and a purchase order of power, and when existence of a site that interchanges balancing power identical to balancing power interchanged by the first site in the first grid and existence of a site that interchanges balancing power identical to balancing power interchanged by the second site in the second grid are detected in accordance with order information stored in the data storage unit.

### Item 7

A program causing a computer to operate as an individual unit in the power transaction control device according to any one of items 1 to 5.

Although the present embodiment has been described above, the present disclosure is not limited to such specific embodiments and can be modified and changed variously within the scope of the present disclosure described in the appended claims.

### REFERENCE SIGNS LIST

1A Power generation unit
2A Server
3A Power distribution unit
4A Accompanying facility
5A Monitoring control device
10A Power distribution network
100 Power transaction control device
110 User IF unit
120 Matching unit
130 Control unit
140 Data storage unit
150 Monitoring unit
200 Power management device
210 Monitoring
220 Control unit
300, 400 Network
1000 Drive device
1001 Recording medium
1002 Auxiliary storage device
1003 Memory device
1004 CPU
1005 Interface device
1006 Display device
1007 Input device
1008 Output device

1. A power transaction control device for virtually performing a power transaction between a plurality of grids, the power transaction control device comprising: a processor; and a memory coupled to the processor, wherein:
the memory is configured to store order information about power trading between the plurality of grids; and
processor is configured to establish the power transaction between a first site of a first grid of the plurality of grids and a second site of a second grid of the plurality of grids when a pair of the first site and the second site each having an identical price for a selling order and a purchase order of power is established, and when existence of a site that interchanges balancing power identical to balancing power interchanged by the first site in the first grid and existence of a site that interchanges balancing power identical to balancing power interchanged by the second site in the second grid are detected in accordance with the order information stored in the memory.

2. The power transaction control device according to claim 1, wherein
the processor is configured to further establish a transaction of power trading between the site that interchanges the balancing power identical to the balancing power interchanged by the first site and the site that interchanges the balancing power identical to the balancing power interchanged by the second site.

3. The power transaction control device according to claim 1, wherein
the site that interchanges the balancing power identical to the balancing power interchanged by the first site and the site that interchanges the balancing power identical to the balancing power interchanged by the second site each include a storage battery and distribute and receive power between the storage battery of the site that interchanges the balancing power identical to the balancing power interchanged by the first site and the storage battery of the site that interchanges the balancing power identical to the balancing power interchanged by the second site.

4. The power transaction control device according to claim 1,
wherein the processor is further configured to receive the purchase order or the selling order from an individual site of each of the plurality of grids, and
wherein an environmental added value is included in a price of power in the selling order received from a site that generates power by renewable energy.

5. The power transaction control device according to claim 1 wherein the processor is further configured to give a point to at least one of a purchaser or a seller of power when the power transaction is established.

6. A power transaction method for virtually performing a power transaction between a plurality of grids performed by a power transaction control device, the power transaction control device including a memory configured to store order information about power trading between the plurality of grids, the power transaction method comprising
establishing the power transaction between a first site of a first grid of the plurality of grids and a second site of a second grid of the plurality of grids when a pair of the first site and the second site each having an identical price for a selling order and a purchase order of power, and when existence of a site that interchanges balancing power identical to balancing power interchanged by the first site in the first grid and existence of a site that interchanges balancing power identical to balancing power interchanged by the second site in the second grid are detected in accordance with the order information stored in the memory.

7. A non-transitory computer-readable medium storing program instructions that cause a computer to perform operations comprising:
establishing a power transaction between a first site of a first grid of a plurality of grids and a second site of a second grid of the plurality of grids when a pair of the first site and the second site each having an identical price for a selling order and a purchase order of power, and when existence of a site that interchanges balancing power identical to balancing power interchanged by the first site in the first grid and existence of a site that interchanges balancing power identical to balancing power interchanged by the second site in the second grid are detected in accordance with order information.
